(19) United States
(12) Patent Application Publication
(10) Pub. No.: US 2007/0122703 A1
(43) Pub. Date: May 31, 2007

(54) Lithium metal oxide electrodes for lithium cells and batteries

(76) Inventors: Pamela Whitfield, Ottawa (CA); Isobel Davidson, Orleans (CA)

Correspondence Address: NATIONAL RESEARCH COUNCIL OF CANADA;1200 MONTREAL ROAD, BLDG M-58, ROOM EG12, OTTAWA, ONTARIO, K1A 0R6, CA

(21) Appl. No.: 10/558,445

(22) PCT Filed: May 27, 2004
(86) PCT No.: PCT/CA04/00770

§ 371 Date: Nov. 6, 2006

Related U.S. Application Data
(60) Provisional application No. 60/473,476, filed on May 28, 2003.

(51) Int. Cl. H01M 4/50; C01G 45/12

(52) U.S. Cl. 429/224; 429/231.1; 423/599

(57) ABSTRACT

A lithium metal oxide positive electrode for a non-aqueous lithium cell or battery is disclosed. The positive electrode comprises a lithium metal oxide having a layered structure and a general formula, after in-situ or ex-situ oxidation, of LiₓMn_{y}M_{1-y} O₂ wherein 0≦×≦0.20, 0<y<1, manganese is in the 4+ oxidation state, and M is one or more the first row transition metals: Ti, V, Cr, Mn, Fe, Co, Ni or Cu, or other specific other canons: Al, Mg, Mo, W, Ta, Si, Sn, Zr, Be, Ca, Ga, and P, which have an appropriate ionic radii to be inserted in to the structure without unduly disrupting it. Usage of the materials of the invention in lithium cells and batteries is disclosed. A process is disclosed for formation of materials of the invention.

### BACKGROUND OF THE INVENTION

This invention relates to lithium metal oxide positive electrodes for non-aqueous lithium cells and batteries. More specifically, it relates to lithium-metal-oxide electrode compositions and structures having a general formula, after in-situ or ex-situ oxidation, of LiₓMn_{y}M_{1-y}O₂ where x≦0.20, 0<y<1, and M is one or more transition metal or other metal cations having appropriate ionic radii to be inserted in to the structure without unduly disrupting it. Cations that have been found as possible fits into similar structures include: all of the first row transition metals, Al, Mg, Mo, W, Ta, Si, Sn, Zr, Be, Ca, Ga, and P. The preferred cations include the transition metals of the first row, such as Ti, V, Cr, Fe, Co, Ni and Cu, and other metals such as Al, Mg, Mo, W, Ta, Ga and Zr. The most preferred cations are Co, Ni, Ti, Al, Cu, Fe and Mg.

The theoretical capacity of the layered lithium metal oxides typically used as cathodes in lithium ion batteries is much higher than the capacities achieved in practice. For lithium ion battery cathodes, the theoretic capacity is the capacity that would be realised if all of the lithium could be reversibly cycled in and out of the structure. For example, LiCoO₂ has a theoretical capacity of 274 mAh/g but the capacity typically achieved in an electrochemical cell is only about 160 mAh/g, equivalent to 58% of theoretical. Somewhat better capacities of up to about 180 mAh/g have been observed by the partial substitution of Co³⁺with other trivalent cations such as nickel [Delmas, Saadoune and Rougier, J. Power Sources, Vol. 43-44, pp. 595-602, 1993].

Materials in the more complex Co, Ni, Mn systems, and in particular the composition LiCo_{1/3}Ni_{1/3}Mn_{1/3}O₂, have been studied extensively by Ohzuku. He has reported capacities of approximately 200 mAh/g with good thermal stability [Ohzuku et al, U.S. Patent Application Ser. No. 10/242,052].

Other related references on R-3m structures of LiMO₂ in which M is a combination of Co, Ni and Mn include:
Yabuuchi and Ohzuku, Journal of Power Sources, Volumes 119-121, 1 Jun. 2003, Pages 171-174.
Wang et al, Journal of Power Sources, Volumes 119-121, 1 Jun. 2003, Pages 189-194.
and
Lu et al, Electrochemical and Solid State Letters, v4 (2001), A200-203.

Numerous other layered structures based on solid solutions of Li₂MO₃ and LiM′O₂ in which M is Mn⁴⁺ or Ti⁴⁺ and M′is a first row transition metal cation or combination of transition metal cations with an average oxidation state of 3+ have been proposed for application as positive electrode materials for lithium ion batteries [U.S. Pat. No. 6,677,082 B2 of Thackeray et al and U.S. patent application, Ser. No. 09/799,935 of Paulsen, Kieu and Ammundsen]. The capacities reported for these materials vary widely with composition but have generally been between about 110 mAh/g and 170 mAh/g.

However layered structures formed from solid solutions of Li₂MnO₃ and either NiO or LiMn_{0.5}Ni_{0.5}O₂ containing manganese as Mn4+ and Ni in the 2+ oxidation state have shown exceptionally large capacities. In particular capacities up to 200 mAh/g at room temperature and 240 mAh/g at 55° C., were observed for some compositions of solid solutions of Li₂MnO₃ and LiNi_{0.5}Mn_{0.5}O₂ on cycling between 2.5 and 4.6 volts [ref. Shin, Sun and Amine, Journal of Power Sources, v112 (2002) 634-638]. Similarly, Lu and Dahn [ref. J. Electrochem. Soc. v149 (2002), A815-822] demonstrated that reversible capacities near 230 mAh/g could be achieved from certain compositions of solid solutions of Li₂MnO₃ and NiO when the cells were charged to 4.8 volts. The capacities observed on cycling these same materials between 3.0 and 4.4 volts were much lower, varying with composition from about 85 to 160 mAh/g. An in-situ transformation was found to occur on charging solid solution phases of Li₂MnO₃ and either NiO or LiNi_{0.5}Mn_{0.5}O₂ to voltages greater than 4.4 volts. The resulting materials were found to have a much higher reversible capacity.

In all previous reports of exceptionally high capacities achieved after charging to voltages greater than 4.4 volts, the materials reported were solid solutions having layered structures containing Mn in the 4+ oxidation state and Ni in the 2+ oxidation state. More typically charging to such high voltages is extremely detrimental to the electrochemical performance of the cathode material.

This invention discloses new compositions of lithium metal oxides formed in-situ in an electrochemical cell by charging to voltages greater than 4.4 volts or ex-situ by chemical oxidation that demonstrate exceptionally high capacities for reversible lithium insertion.

In particular, in this invention it is disclosed that compositions containing no Ni²⁺ at all, such as solid solutions of Li₂MnO₃ and LiCoO₂ can exhibit unusually large capacities after being severely oxidized by charging to high voltages.

### SUMMARY OF THE INVENTION

This invention discloses new compositions of lithium metal oxides formed in-situ in an electrochemical cell by charging to voltages greater than 4.4 volts, or ex-situ by chemical oxidation that demonstrate exceptionally high capacities for reversible lithium insertion.

In particular, in this invention it is disclosed that compositions containing no Ni²⁺ at all, such as solid solutions of Li₂MnO₃ and LiCoO₂ can exhibit unusually large capacities after being severely oxidized by charging to high voltages.

According to one aspect of the invention, we provide novel lithium metal oxide materials of general formula LiₓMn_{y}M_{1-y}O₂ , where 0≦x≦0.20 and 0<y<1, Mn is Mn⁺⁴ and M is one or more transition metal or other cations having appropriate sized ionic radii to be inserted into the structure without unduly disrupting it.

According to another aspect of the invention, the novel materials of the invention are layered crystallographic structures useful as positive electrodes in a non-aqueous lithium cell, such as a lithium ion cell or battery.

According to yet another aspect of the invention, a process for making the novel lithium metal oxide materials of general formula LiₓMn_{y}M_{1-Y}O₂, where 0 ≦x≦0.20 and 0<y<1 and M is one or more transition metal or other cations having appropriate ionic radii to be inserted in to the structure without unduly disrupting it, is provided, comprising preparation of high lithium content precursors using a modification of the well known “sucrose method” from that originally reported in the literature [Das, Materials Letters, v47 (2001), 344-350], and then modifying the composition and structure further by in-situ or ex-situ oxidation. The modifications include an in-situ transformation, which occurs on charging solid solution phases of Li₂MnO₃ and either LiNi_{0.5}Mn_{0.5}O₂ or NiO to voltages greater that 4.4 volts, preferably in a range of 4.4 to 5 volts. The resulting materials were found to have a much higher reversible capacity.

We have discovered that the anomalous capacities previously reported in the Mn—Ni systems are a more general process than previously thought. There are a number of metal ions, that can be substituted into such materials in place of, or in addition to, the Ni cations. These choices are based on “ionic radii”, i.e. whether they can fit into the structure without unduly disrupting it. Cations that have been found as possible fits into similar structures include: all of the first row transition metals, Al, Mg, Mo, W, Ta, Si, Sn, Zr, Be, Ca, Ga, and P. The preferred cations are the transition metals of the first row, such as Ti, V, Cr, Fe, Co, Ni and Cu, and other metals such as Al, Mg, Mo, W, Ta, Ga and Zr. Such compositions can exhibit unusually high capacity, in excess of the conventional theoretical capacities that are calculated on the basis of conventional views on the accessible range of oxidations states. For example, it is conventionally assumed that neither Mn⁴⁺ nor O²⁻ will be oxidized under the conditions of the application. The capacities obtained from these materials is beyond that calculated using such assumptions. It is also possible to substitute other cations including electrochemically inert, Al³⁺ and still obtain high capacities and stable cycling (example 5). Furthermore, the Al-doping had the effect of increasing the average discharge voltage of the material. The mechanism for the production of these anomalous capacities seems to lie with the Li₂MnO₃, or possibly the Mn⁴⁺, content, and the unusual stability of these materials from undesirable reactions with the electrolyte at high voltages.

Some compositions in the Li₂MnO₃—LiCoO₂ solid solution series have been reported previously. However in prior studies, these materials were not charged beyond 4.4V, and the authors reported the expected reduction in capacity on the addition of Mn⁴⁺. [Numata and Yamanaka, Solid State Ionics, vol. 118 (1999) pp. 117-120; Numata, Sakati and Yamanaka, Solid State Ionics, vol 117 (1999) pp 257-263]

Zhang et al [Journal of Power Sources, v117 (2003), 137-142] have described the behaviour of materials where Mn is replaced by Ti. The addition of ‘inert’ Li₂TiO₃ was found to have a detrimental effect on the discharge capacities.

A broad range of chemical modifications of Li₂MnO₃ by addition of LiMO₂ have been shown to have exceptionally large discharge capacities. Most of these compositions have never been reported previously and represent a series of novel materials.

Some of the novel materials tested produced capacities that cannot be explained conventionally. Results also indicate an unusual ability to tune the discharge voltage through relatively small variations in the composition.

Some of the more complex novel materials have 5 different species sharing a single crystallographic site. Many standard synthetic techniques would not provide sufficient homogeneity to achieve a single-phase material. The synthetic techniques used to date to achieve this level of homogeneity are a modified “sucrose-method” based dispersion/combustion technique and high-energy ball-milling.

### BRIEF DESCRIPTION OF THE DRAWINGS

FIG. 1. Ternary phase diagram for the Li₂MnO₃—LiCoO₂—LiNiO₂ system. The diamonds represent single phase materials synthesised and characterised.

FIG. 2. X-ray diffraction patterns for materials in the Li₂MnO₃—LiNi_{0.75}Co_{0.25}O₂ solid solution series.

FIG. 3. X-ray diffraction patterns for materials in the Li_{1.2}Mn_{0.4}Ni_{0.4-X}Co_{X}O₂ (0≦x≦0.4) series.

FIG. 4. First three room temperature charge-discharge cycles of materials in the Li_{1.2}Mn_{0.4}Ni_{0.4-x}CoₓO₂ series calcined at 800° C. Cycling was carried out between 2.0-4.6V at 10 mA/g.

FIG. 5. Discharge capacities for materials in the series Li_{1.2}Mn_{0.4}Ni_{0.4-x}COₓO₂ calcined at 740° C. as calculated from the mass of the lithium metal oxide before charging and as a value normalized to the transition metal content.

FIG. 6. Discharge capacities for materials in the series Li_{1.2}Mn_{0.4}Ni_{0.4-x}Co_{xO}₂ calcined at 800° C. as calculated from the mass of the lithium metal oxide before charging and as a value normalized to the transition metal content.

FIG. 7. Discharge capacities for materials in the series Li_{1.2}Mn_{0.4}Ni_{0.4-x}CoₓO₂ calcined 900° C. as calculated from the mass of the lithium metal oxide before charging and as a value normalized to the transition metal content. A rate excursion to 30 mA/g was carried out on Li_{1.2}Mn_{0.4}Co_{0.4}O₂ for the 3 cycles as indicated.

FIG. 8. Capacities and average discharge voltage of Li_{1.2}Mn_{0.4}Ni_{0.3}Co_{0.1}O₂ calcined at 800° C. when cycled at 55° C. as calculated from the mass of the lithium metal oxide before charging and as a value normalized to the transition metal content.

FIG. 9. X-ray diffraction patterns for materials in the Li₂MnO₃—LiNi_{0.5}Co_{0.5}O₂ solid solution series calcined at 800° C.

FIG. 10. Discharge capacities for materials in the Li₂MnO₃—LiNi0.5Co_{0.5}O₂ solid solution series calcined at 800° C.

FIG. 11. X-ray diffraction patterns of a number of substituted analogues calcined at 800° C.

FIG. 12. Charge-discharge voltage curve for different materials calcined at 800° C. during the 30th cycle.

### DETAILED DESCRIPTION OF THE INVENTION

This invention relates to lithium metal oxide positive electrodes for a non-aqueous lithium cell having a layered structure and a general formula, after in-situ or ex-situ oxidation, of LiₓMn_{y}M_{1-y}O₂ where x≦0.20, manganese is in the 4+ oxidation state, and M is one or more transition metal or other metal cations having appropriate ionic radii to be inserted in to the structure without unduly disrupting it. Cations that have been found as possible fits into similar structures include: all the first row transition metals, Al, Mg, Mo, W, Ta, Si, Sn, Zr, Be, Ca, Ga, and P. The preferred cations are the transition metals of the first row, such as Ti, V, Cr, Fe, Co, Ni and Cu, and other metals such as Al, Mo, W, Ta, Ga and Zr. The most preferred cations are Co, Ni, Ti, Fe, Cu and Al.

The similarities in electrochemical properties between wide ranges of compositions described in the examples would suggest a common mechanism. The capacities observed in these materials are anomalously large in relation to their composition and the conventional views of accessible oxidation states. This is especially so for compositions that are solid solutions between Li₂MnO₃ and LiCoO₂ in which Ni²⁺ is not present at all and the cobalt is in the trivalent state.

For compositions in the series Li_{1.2}Mn_{0.4}Ni_{0.4-x}CoₓO₄, the theoretical capacities should be:
Mn⁴⁺+M³⁺→Mn⁴⁺+M⁴⁺˜125 mAh/g

In the case of Li_{1.2}Mn_{0.4}Co_{0.4}O₂ calcined at 900° C. taper-charged at low current to 4.6V, the first charge capacity was found to be 345 mAh/g, leaving a discrepancy of 220 mAh/g. Assuming that the oxidised species is oxide rather than other cell components, this would lead to:

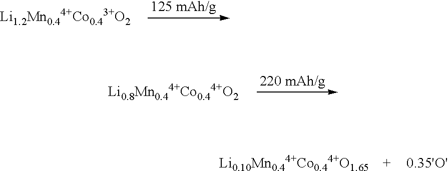

Li_{0.1}Mn_{0.4}Co_{0.40}O_{1.675} can be equivalently described as Li_{0.125}Mn_{0.5}Co_{0.5}O₂ , which would yield a theoretical discharge capacity of approximately 240 mAh/g when correcting for the mass of the original active material. This mechanism would account for the different voltage profiles that the materials exhibit from cycle 2 onwards. An interesting observation is that the voltage curve of Li_{1.2}Mn_{0.4}Co0.4O₂ after 2 full cycles is remarkably similar to that observed for LiCo_{0.5}Mn_{0.5}O₂ [Kajiyama et al, Solid State lonics, v149 (2002) 39-45], the small low voltage feature early in the charge curve being common to both materials. In addition, the voltage curve of Li_{1.2}Mn_{0.4}Ni_{0.4}O₂ once the formation step is finished is similar to that observed for LiNi_{0.5}Mn_{0.5}O₂ [Makimura and Ohzuku, Journal of Power Sources, v119-121 (2003) 156-160].

After the formation step from charging to high voltages, the new in-situ produced cathode material can cycle with up to 95-98% reversibility over an extended period of time. This is significantly better behaviour than LiₓMn_{0.5}Co_{0.5}O₂ prepared by chemical means, and is reminiscent of LiMn₂O₄ spinel produced in-situ by cycling o-LiMnO₂ [Gummow et al, Materials Research Bulletin, v28 (1993) 1249-1256]. The discharge capacity and capacity retention of the Al-doped material (given in table 1) are exceptionally good assuming in-situ formation of LiNi_{0.5}Co_{0.375}Al_{0.125}O₂, with a theoretical capacity of 204 mAh/g

The inclusion of Mn⁴⁺ has been reported to increase thermal stability, voltage stability, high temperature cycleability and discharge capacities.

Some of the more complex materials made have 5 different species sharing a single crystallographic site. Many standard synthetic techniques would not provide sufficient homogeneity to achieve a single-phase material. The synthetic techniques used to date to achieve this level of homogeneity are a chelation-based combined dispersion/combustion technique and high-energy ball-milling. The method has been modified from the sucrose-based synthesis originally reported in the literature [Das, Materials Letters, v47 (2001), 344-350], and is easily capable of producing complex oxide materials with crystallites of sizes<100 nm.

The following examples of lithium metal oxide positive electrodes for a non-aqueous lithium cell having a layered structure and a general formula, after in-situ or ex-situ oxidation, of LiₓMn_{y}M_{1-y}O₂ where x<0.20, manganese is in the 4+ oxidation state, and M is one or more transition metal or other metal cations having appropriate ionic radii describe the principles of the invention as contemplated by the inventors, but they are not to be construed as limiting examples.

### EXAMPLE 1

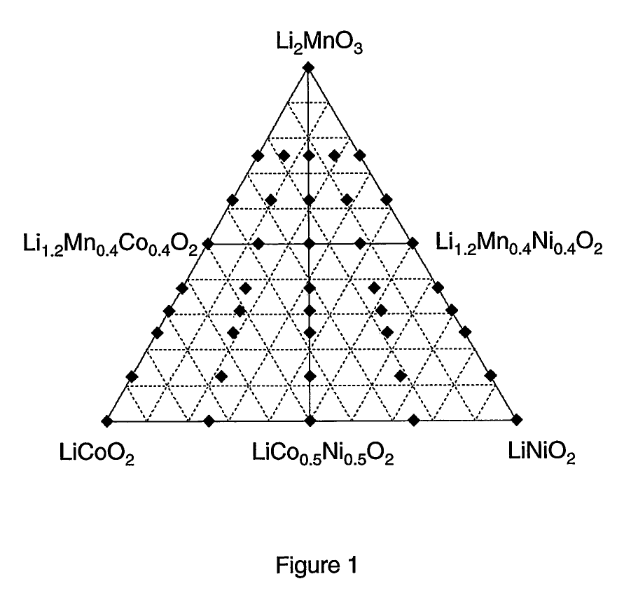

This example describes the typical synthesis route of materials in the (1-x)Li₂MnO₃: xLiNi_{1-y}Co_{y}O₂ (0≦x≦1; 0≦y≦1) solid solution series. Mn(NO₃)₂.4H₂O, Ni(NO₃)₂.6H₂O, Co(NO₃)₂. H₂O and LiNO₃ were dissolved fully in water in the required molar ratios. Sucrose was added in an amount corresponding to greater than 50% molar quantity with regard to the total molar cation content. The pH of the solution was adjusted to pH1 with concentrated nitric acid. The solution was heated to evaporate the water. Once the water had mostly evaporated the resulting viscous liquid was further heated. At this stage the liquid foamed and began to char. Once charring was complete the solid carbonaceous matrix spontaneously combusted. The resulting ash was calcined in air at 800° C., 740° C. or 900° C. for 6 hours. FIG. 1 shows the ternary phase diagram describing the (1-x) Li₂MnO₃: x LiNi_{1-y}CO_{y}O₂ solid solution series, with the materials synthesized being indicated by black diamonds.

The materials were analyzed with an X-ray powder diffractometer using CuKα radiation. The ash precursors were found to contain unreacted Li₂CO₃. However, after calcination at 800° C. in air for 6 hours, there was no longer any evidence of Li₂CO₃ in the diffraction patterns of the product materials.

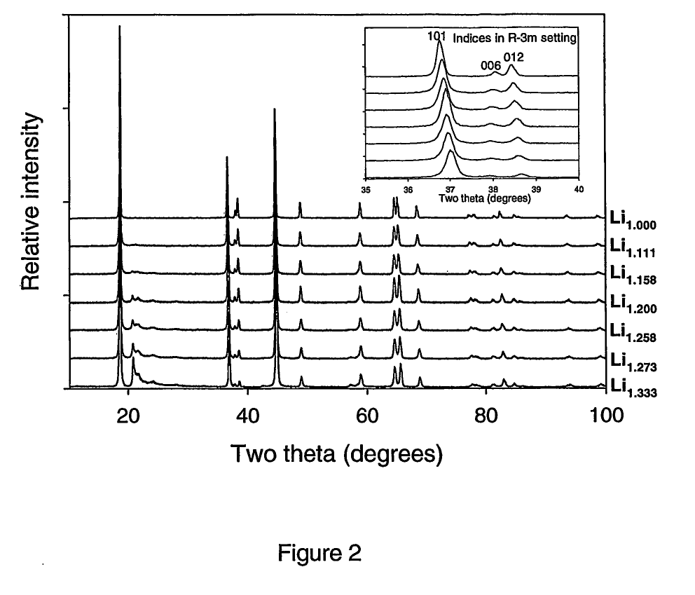

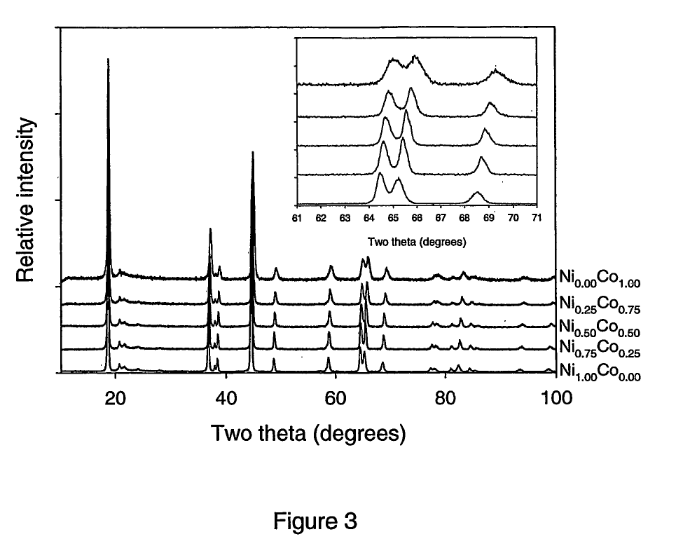

FIGS. 2 and 3 show the X-ray diffraction patterns for materials in the (1-x) Li₂MnO₃:LiNi_{0.75}Co_{0.25}O₂ (0≦x≦1) and Li_{1.2}Mn_{0.4}Ni_{0.4-x}CoₓO₂ (0≦x≦0.4). These series correspond to the vertical and horizontal tie-lines shown in FIG. 1. There are no visible reflections due to Li₂CO₃ in any of the calcined materials, indicating that all of the materials were fully reacted. The materials in FIG. 2 show a change from Li₂MnO₃-like patterns to layered R-3m-like patterns. The materials in FIG. 3 all retain features of a Li₂MnO₃-like pattern.

### EXAMPLE 2

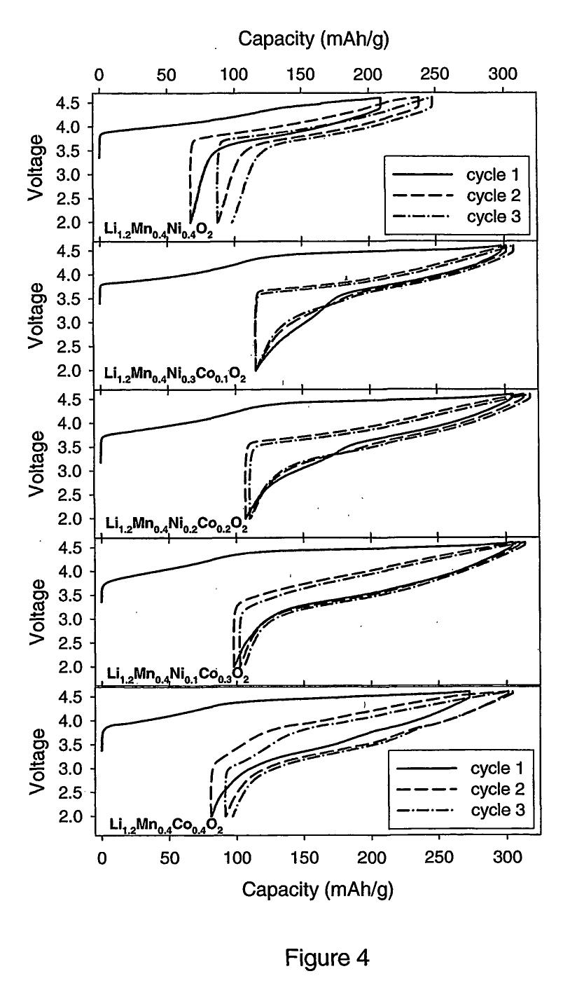

Electrodes were fabricated from materials prepared as in example 1 by mixing approximately 78 wt % of the oxide material, 7 wt % graphite, 7 wt % Super S, and 8 wt % poly(vinylidene fluoride) as a slurry in 1-methyl-2-pyrrolidene (NMP). The slurry was then cast onto aluminum foil. After drying at 85° C., and pressing, circular electrodes were punched. The electrodes were assembled into electrochemical cells in an argon-filled glove box using 2325 coin cell hardware. Lithium foil was used as the anode, porous polypropylene as the separator, and 1M LiPF₆ in 1:1 dimethyl carbonate (DMC) and ethylene carbonate (EC) electrolyte solution. A total of 70 μl of electrolyte was used to saturate the separator. The cells were cycled at constant current of 10 mA/g of active material between 2.0 and 4.6V at room temperature. The capacities observed on the first and thirtieth cycles are given in table 1. FIG. 4 shows the electrochemical behavior of the first 3 cycles of materials in the Li_{1.2}Mn_{0.4}Ni_{0.4-x}CoₓO₂ (0≦x≦0.4) series prepared as in example 1 and calcined at 800° C. The voltage curves in FIG. 4 show that a formation step occurs during early cycling. For x=0.1, 0.2 and 0.3, this formation is completed after the first cycle, after which the materials cycle with high capacity and reversibility. Consequently, the desired material is that formed during oxidation rather than the chemically synthesized composition. For x=0.4, this formation requires more than one cycle, with increased lithium extraction also on the second charge. The cell polarization of x=0.0, indicates that the formation is extremely slow, and would require higher voltages, or smaller particle size.

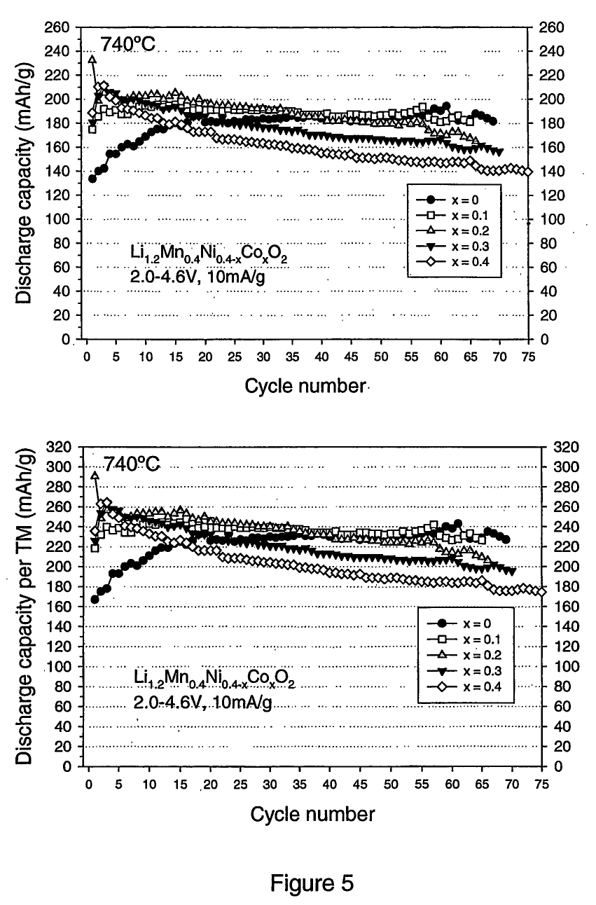

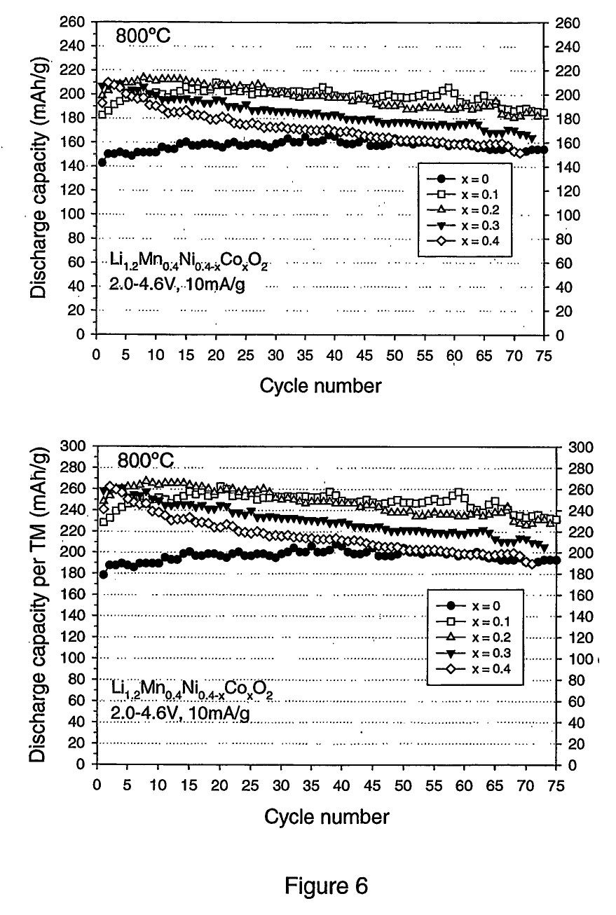

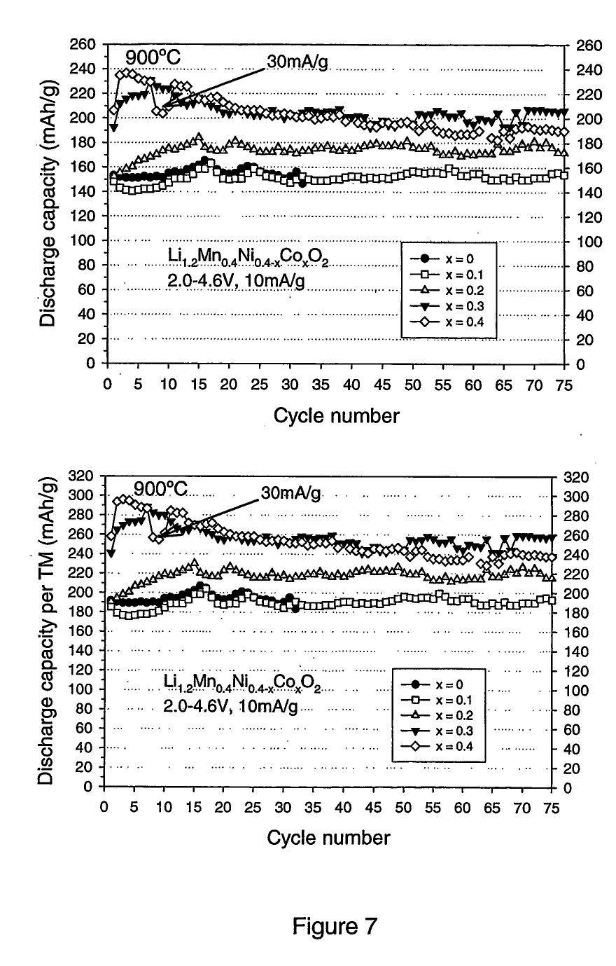

FIGS. 5-7 show the discharge capacities of Li_{1.2}Mn_{0.4}Ni_{0.4-x}CoₓO₂ materials calcined at 740, 800 and 900° C. respectively. It can be seen that the trends in discharge capacity vary with both composition and calcination temperature. The materials described here contain substantially less transition metals than conventional lithium-battery cathode materials. Given that the transition metals content contributes substantially to the cost of production, it is useful to compare the capacities in terms of the transition metal (TM) content normally found in current lithium battery cathode materials, i.e. LiMO₂. Consequently, additional plots are shown in FIGS. 5-7, describing the discharge capacity per transition metal equivalent. In the case of the Li_{1.2}Mn_{0.4}Ni_{0.4-x}CoₓO₂ series, the ratio of Li:TM is 1.2:0.8, as opposed to 1:1 in conventional lithium battery cathode materials, so there is a scaling factor of 1/0.8=1.25 in order to produce the capacity per TM equivalent. For another material in the (1-x)Li₂MnO₃: xLiNi_{1-y}Co_{y}O₂ (0≦x≦1; 0≦y≦1) solid solution series, e.g. Li_{1.1}₅₈Mn_{0.316}Ni_{0.263}Co_{0.263}O₂, the scaling factor would be 1/0.828=1.188.

An ultimate charged composition may be calculated using the total charge capacity taking into account any early cycling irreversibility, and results obtained from atomic absorption spectroscopy for the cation contents. Atomic absorption ratios were calculated such that the total cation content equals 2 in a LiMO₂ format. For materials in the series Li₂MnO₃: LiNi₁₋ₓCoₓO₂ (0≦x≦0.4) calcined at 800° C., the results of these calculations are shown in table 2.

The results show that the compositions with x=0.1, 0.2 and 0.3 produce charged materials with lithium contents<0.2, and x=0.4 very close to 0.2. The material with x=0.0 did not achieve the same extent of delithiation and exhibited lower capacities on cycling.

### EXAMPLE 3

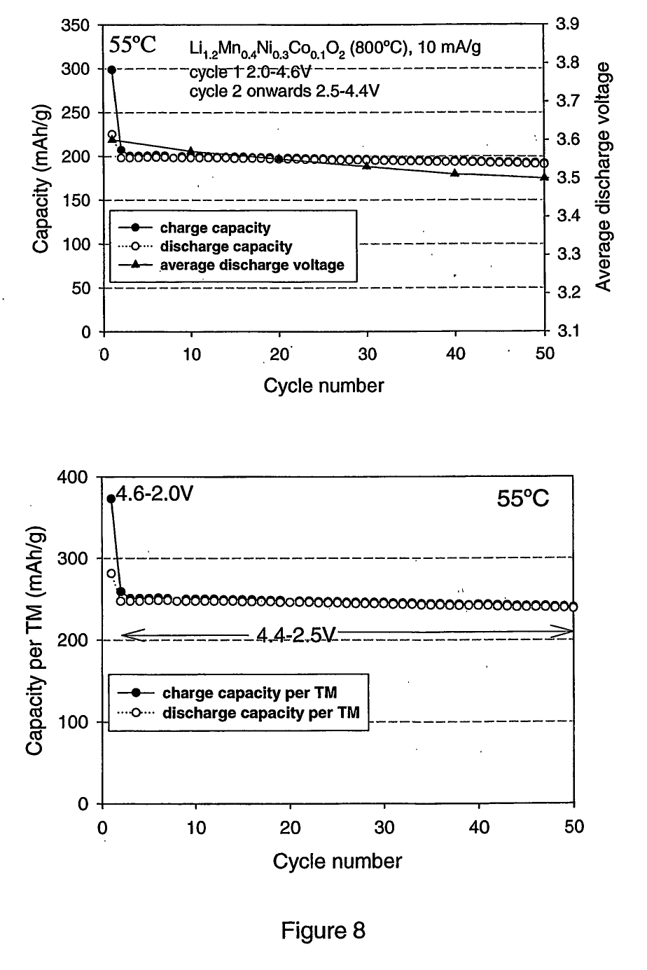

Many lithium battery cathode materials do not perform well at elevated temperatures, their discharge capacities on extended cycling fading rapidly. The electrochemical behavior of the materials of the invention were evaluated at elevated temperature. identical cells were used to those at room temperature. FIG. 8 shows the discharge capacity of 800° C.-calcined Li_{1.2}Mn_{0.4}Ni_{0.3}Co_{0.1}O₂ at 55° C. The voltage limits after the first cycle were reduced to avoid electrolyte decomposition. The material exhibited very stable capacities with very high reversibility in cycle 2 onwards. The average discharge voltage also remained quite stable for 55° C. cycling.

### EXAMPLE 4

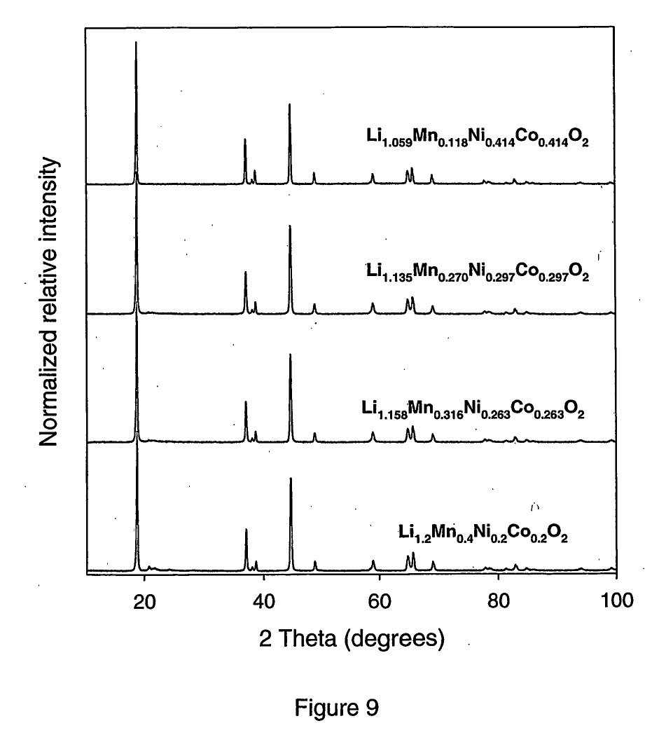

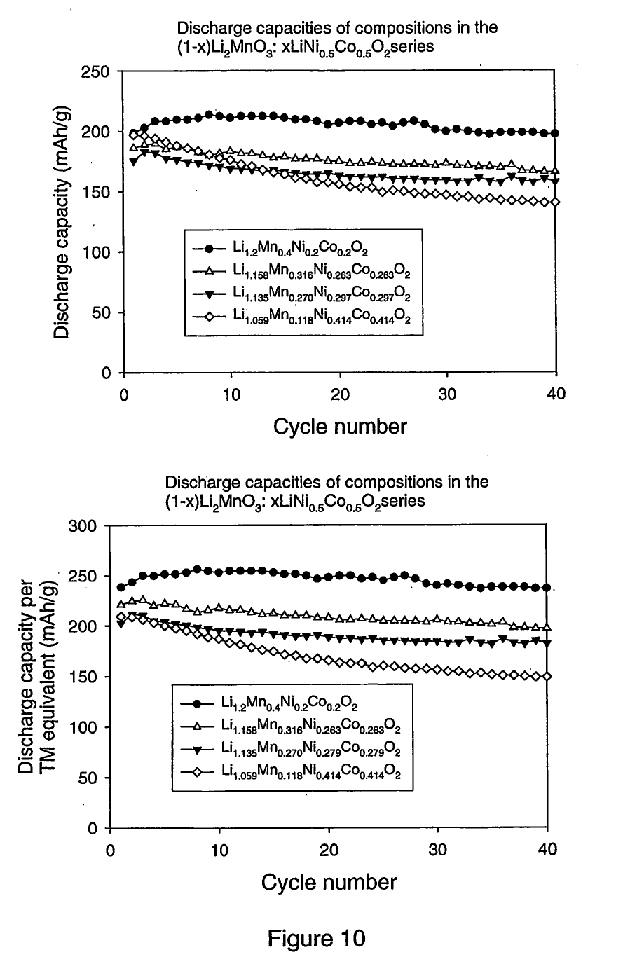

Electrochemical cells were fabricated as in example 2 from compositions in the series (1-x) Li₂MnO₃: x LiNi_{0.5}Co_{0.2} that were prepared as in example 1 and calcined at 800° C. These cells were tested as in example 2 between voltage limits of 2.0 and 4.6 volts. The diffraction patterns for various compositions in the series (1-x) Li₂MnO₃: x LiNi_{0.5}CO_{0.5}O₂ are shown in FIG. 9 and the corresponding electrochemical performance is illustrated in FIG. 10. An additional plot corresponding to the discharge capacities normalized per transition metal is also shown in FIG. 10. The theoretical capacities based on conventional views of accessible oxidation states and structure as well as the accumulated charge and ultimate lithium content in the fully charged state are listed in table 3.

### EXAMPLE 5

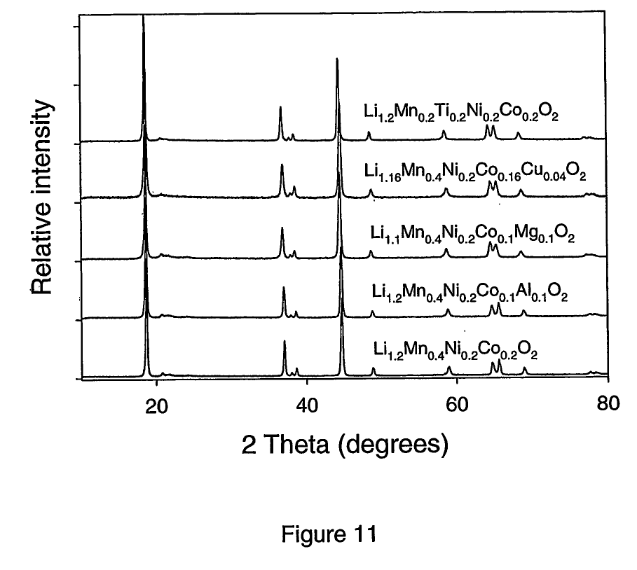

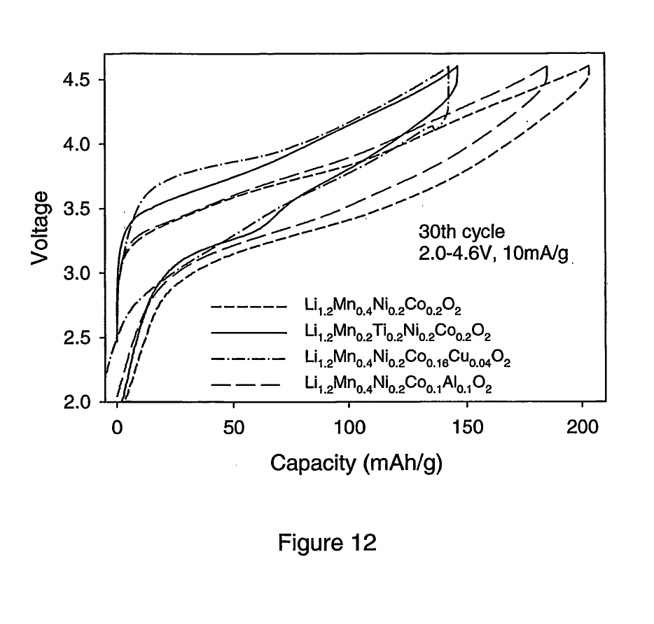

Compositions with additional substitutents have also been investigated. FIG. 11 shows that materials with Ti, Cu and Al substitution could also be produced single-phase. These materials were produced using the same chelation-based process, but with the addition of the required molar quantity of precursor. The precursors used were (NH₄)₂TiO(C₂H₄)₂.H₂O, Cu(NO₃)₂.3H₂O and Al(NO₃)₃.9H₂O. The discharge capacities obtained for the Al, Cu and Ti-substituted materials after the first and thirtieth cycles are tabulated in table 1. It can. be seen that Cu and Ti-doping impacted the discharge capacities obtained, but these materials cycled with very stable capacity. Given the very high amount of Al doped into Li_{1.2}Mn_{0.4}Ni_{0.2}Co_{0.1} Al_{0.1}O₂, the discharge capacities obtained are quite high. Such a high level of Al in a conventional lithium battery cathode material would be expected to impact severely on the discharge capacities obtained. FIG. 12 shows the charge-discharge voltage curves for the same materials on the 30th cycle. It can be seen that the Ti-doping has a particular effect on the discharge curve, with a distinct kink at approximately 3.3V. The Al-doping has the effect of increasing the average discharge voltage of the material. Given the very high amount of Al doped into Li_{1.2}Mn_{0.4}Ni_{0.2}Co_{0.1}Al_{0.1}O₂, the discharge capacities obtained are quite high, with a discharge capacity of 186 mAh/g after 30 cycles.

The theoretical capacities, for the Al and Ti substituted materials, based on conventional views of accessible oxidation states and structure as well as the accumulated charge and ultimate lithium content in the fully charged state are listed in table 3.

### EXAMPLE 6

The use of nitrates is not necessary for the production of single phase Li_{1.2}Mn_{0.4}Ni_{0.3}Co_{0.1}O₂. The X-ray diffraction verified that single-phase materials can be produced using all acetate salts or a combination of lithium formate and metal acetate salts as precursors. All of the other processing conditions were identical to examples 1 and 2. The discharge capacities obtained using nitrates and lithium formate with acetates as the precursors are given in table 1. it can be seen that the performance is actually improved using the lithium formate with acetates. After 30 cycles the discharge capacity is approximately 20 mAh/g higher than using nitrate precursors.

### EXAMPLE 7

This example shows that materials with similar performance may be produced by methods other than a solution-based chelation mechanism. Li₂MnO₃ and LiCoO₂ were mixed in a 1:1 molar ratio, and milled in a high-energy ball-mill for a total of 9 hours. The resulting powder was calcined in air at 740° C. in air for 6 hours. X-ray diffraction of the materials both before and after calcination showed no indication of the presence of Li₂MnO₃. The material after calcination was single-phase and more crystalline than the milled precursor.

The discharge capacities, listed in table 1, obtained with the ball-mill produced material under the same cycling conditions as example 2 were substantially similar to those obtained with material produced using the solution-based chelation process.

TABLE 1
Discharge capacities at the first and thirtieth cycles for various
compositions of x Li₂MnO₃:(1−x) LiMO₂. The capacities are
calculated first as mAh/g based as on the weight of the lithium
metal oxide as prepared, before in-situ oxidation, and then
normalized to a per transition metal capacity.

| | | 1st | | 30th |
|---|---|---|---|---|
| | 1st | discharge | 30th | discharge |
| | discharge | capacity | discharge | capacity |
| | capacity | per TM | capacity | per TM |
| Composition | (mAh/g) | (mAh/g) | (mAh/g) | (mAh/g) |
| EXAMPLE 2 - 740° C. | | | | |
| Li_{1.2}Mn_{0.4}Ni_{0.4}O₂ | 134 | 168 | 184 | 230 |
| Li_{1.2}Mn_{0.4}Ni_{0.3}Co_{0.1}O₂ | 175 | 219 | 192 | 240 |
| Li_{1.2}Mn_{0.4}Ni_{0.2}Co_{0.2}O₂ | 232 | 290 | 192 | 240 |
| Li_{1.2}Mn_{0.4}Ni_{0.1}Co_{0.3}O₂ | 180 | 225 | 177 | 222 |
| Li_{1.2}Mn_{0.4}Co_{0.4}O₂ | 189 | 236 | 164 | 205 |
| EXAMPLE 2 - 800° C. | | | | |
| Li_{1.2}Mn_{0.4}Ni_{0.4}O₂ | 143 | 179 | 159 | 199 |
| Li_{1.2}Mn_{0.4}Ni_{0.3}Co_{0.1}O₂ | 183 | 229 | 202 | 253 |
| Li_{1.2}Mn_{0.4}Ni_{0.2}Co_{0.2}O₂ | 199 | 249 | 200 | 250 |
| Li_{1.2}Mn_{0.4}Ni_{0.1}Co_{0.3}O₂ | 207 | 259 | 186 | 233 |
| Li_{1.2}Mn_{0.4}Co_{0.4}O₂ | 193 | 241 | 172 | 215 |
| EXAMPLE 2 - 900° C. | | | | |
| Li_{1.2}Mn_{0.4}Ni_{1.4}O₂ | 154 | 193 | 152 | 190 |
| Li_{1.2}Mn_{0.4}Ni_{0.3}Co_{0.1}O₂ | 148 | 185 | 147 | 184 |
| Li_{1.2}Mn_{0.4}Ni_{0.2}Co_{0.2}O₂ | 152 | 190 | 174 | 218 |
| Li_{1.2}Mn_{0.4}Ni_{0.1}Co_{0.3}O₂ | 192 | 240 | 203 | 254 |
| Li_{1.2}Mn_{0.4}Co_{0.4}O₂ | 206 | 258 | 203 | 254 |
| EXAMPLE 3 | | | | |
| Li_{1.2}Mn_{0.4}Ni_{0.3}Co_{0.1}O₂ | 225 | 281 | 195 | 244 |
| (55° C.) | | | | |
| EXAMPLE 4 | | | | |
| Li_{1.158}Mn_{0.316}Ni_{0.263} | 186 | 221 | 173 | 205 |
| Co_{0.263}O₂ | | | | |
| Li_{1.135}Mn_{0.270}Ni_{0.297} | 175 | 202 | 159 | 184 |
| Co_{0.298}O₂ | | | | |
| Li_{1.059}Mn_{0.118}Ni_{0.414} | 197 | 209 | 147 | 156 |
| Co_{0.414}O₂ | | | | |
| LiNi_{0.5}Co_{0.5}O₂ | 162 | 162 | 143 | 143 |
| EXAMPLE 5 | | | | |
| Li_{1.2}Mn_{0.2}Ti_{0.2}Ni_{0.2} | 156 | 195 | 175 | 219 |
| Co_{0.2}O₂ | | | | |
| Li_{1.2}Mn_{0.4}Ni_{0.2} | 179 | 224 | 186 | 233 |
| Co_{0.1}Al_{0.1}O₂ | | | | |
| Li_{1.16}Mn_{0.4}Ni_{0.2}Co_{0.16} | 150 | 188 | 150 | 188 |
| Cu_{0.04}O₂ | | | | |
| EXAMPLE 6 | | | | |
| nitrates | 208 | 260 | 186 | 233 |
| Li formate + acetates | 189 | 236 | 215 | 269 |
| EXAMPLE 7 | | | | |
| Li_{1.2}Mn_{0.4}Co_{0.4}O₂ | 196 | 245 | 167 | 209 |
| (milled) | | | | |
| Li_{1.2}Mn_{0.4}Co_{0.4}O₂ | 188 | 235 | 164 | 205 |
| (sucrose) | | | | |

TABLE 2
Tabulation of lithium contents for materials in the
series Li₂MnO₃:LiNi₁₋ₓCoₓO₂ (0 ≦ x ≦ 0.4)
calcined at 800° C., as made and after in-situ
formation in an electrochemical cell.

| | | Accumulated | |
|---|---|---|---|
| | Li content | charge | Ultimate charged Li |
| x | (AA) | (mAh/g) | content |
| 0.0 | 1.162 | 263 | 0.32 |
| 0.1 | 1.146 | 298 | 0.20 |
| 0.2 | 1.174 | 308 | 0.20 |
| 0.3 | 1.158 | 334 | 0.09 |
| 0.4 | 1.172 | 301 | 0.20 |

TABLE 3
Tabulation of theoretical capacities, accumulated charge
and lithium contents after in-situ formation in an electrochemical
cell for various compositions in the series x Li₂MnO₃:(1−x) LiMO₂
calcined at 800° C.

| | Conventional | | |
|---|---|---|---|
| | theoretical | Actual | Ultimate |
| | charge | accumulated | charged |
| | capacity | charge | Li |
| Nominal composition | (mAh/g) | (mAh/g) | content |
| Li_{1.2}Mn_{0.2}Ti_{0.2}Ni_{0.2}Co_{0.2}O₂ | 127 | 318 | 0.20 |
| Li_{1.2}Mn_{0.4}Ni_{0.2}Co_{0.1}Al_{0.1}O₂ | 97 | 298 | 0.28 |
| Li_{1.158}Mn_{0.316}Ni_{0.263}Co_{0.263}O₂ | 160 | 301 | 0.17 |
| Li_{1.135}Mn_{0.270}Ni_{0.297}Co_{0.298}O₂ | 178 | 323 | 0.05 |
| Li_{1.059}Mn_{0.118}Ni_{0.414}Co_{0.414}O₂ | 235 | 273 | 0.10 |

1. A lithium-metal-oxide electrode compositions and structures having a layered crystallographic structure and the general formula LiₓMn_{y}M_{1-y}O₂ where 0≦x≦0.20, 0<y<1, manganese is in the 4+ oxidation state and M is one or more transition metal or other cations.

2. A material according to claim 1, wherein M is chosen from all of the other first row transition metals: Ti, V. Cr, Fe, Co, Ni and Cu, and other cations with appropriate sized ionic radii: Al, Mg, Mo, W, Ta, Si, Sn, Zr, Be, Ca, Ga, and P, but is not solely Ni.

3. A material according to claim 1, wherein M is one or more transition metal or other cations chosen from the other first row transition metals: Ti, V. Cr, Fe, Co, Ni and Cu, and other metal cations such as Al, Mo, W, Ta, Ga and Zr.

4. A material according to claim 1, wherein M is one or more transition metal or other metal cations chosen from the first row transition metals and Al.

5. The use of a material according to claim 1, as positive electrode in a non-aqueous lithium cell or battery, such as a lithium ion cell.

6. A process for making a material of formula LiₓMn_{y}M_{1-y}O₂, wherein x≦0.2, 0<y<2, Mn is Mn+4 and M is one or more transition metal cations or other cations, comprising providing a starting material of formula Li₁₊ₓMn_{y}M_{1-y}O₂, wherein x is equal to or greater than 0, and M is one or more transition metal or other cations, as a cathode in a lithium ion cell, and charging the cell to a high voltage.

7. A process according to claim 6, wherein M is chosen from all of the other first row transition metals: Ti, V. Cr, Fe, Co, Ni and Cu, and other cations with appropriate sized ionic radii: Al, Mg, Mo, W, Ta, Si, Sh, Zr, Be, Ca, Ga, and P, but is not solely Ni.

8. A process according to claim 6, wherein M is one or more transition metal or other metal cations chosen from the other first row transition metals: Ti, V. Cr, Fe, Co, Ni and Cu. and other cations such as Al, Mo, W, Ta, Ga and Zr.

9. A process according to claim 6, wherein M is one or more transition metal or other metal cations chosen from the first row transition metals and Al.

10. A process according to claim 6, wherein the voltage is in the range of 4.4 to 5 volts.
